(19) United States
(12) Patent Application Publication
(10) Pub. No.: US 2019/0171759 A1
(43) Pub. Date: Jun. 6, 2019

(54) ISSSAPHACT PERSON SEARCH MODULE

(71) Applicant: LUMMISHA C. LUNG, Lancaster, CA (US)

(72) Inventor: Mychael Alexander GARY, Lancaster, CA (US)

(73) Assignee: LUMMISHA C. LUNG, Lancaster, CA (US)

(21) Appl. No.: 15/829,998

(22) Filed: Dec. 4, 2017

(51) Int. Cl. G06F 17/30; G06F 17/24

(52) U.S. Cl. CPC G06F 17/30702; G06F 17/243

(57) ABSTRACT

After the database is built within the app, as more people find out about the app and as the database gets more input, the app will be more and more interesting to the users who access the app to search for a person. The suspense and the need to want to know how many other people know this person will be very powerful.

### BACKGROUND

People engage in search engines to answer questions around the world every day. Whether they are searching for an upcoming movie, or the location of a movie theatre, search engines are utilized to answer questions. People also utilize search engines to obtain information about people

### BRIEF SUMMARY OF THE INVENTION

The purpose of this invention is to create suspense in application users by providing limited information. When the user downloads the application, they are expecting to obtain information about a person. Also when a user downloads the application, they will be asked to provide information about every person they know and whether they know them socially, personally, or closely. When a person searches on the “ISSSAPHACT” application they will input last two digits of the person's phone number with the area code and the first initial of the first and last name. There will be an option to purchase more letters of the name and digits of the phone number to narrow down the results. Then once the user is satisfied with how narrow the results are, they will be able to see how many people know this person socially, personally, or closely.

### BRIEF DESCRIPTION OF THE DRAWINGS

FIG. 1 Steps 1.A through 1.R describe all of the steps from sign in to the last step on the search side of the app.

FIG. 2 Steps 2.A through 2.D describe all of the steps for the input side of the app.

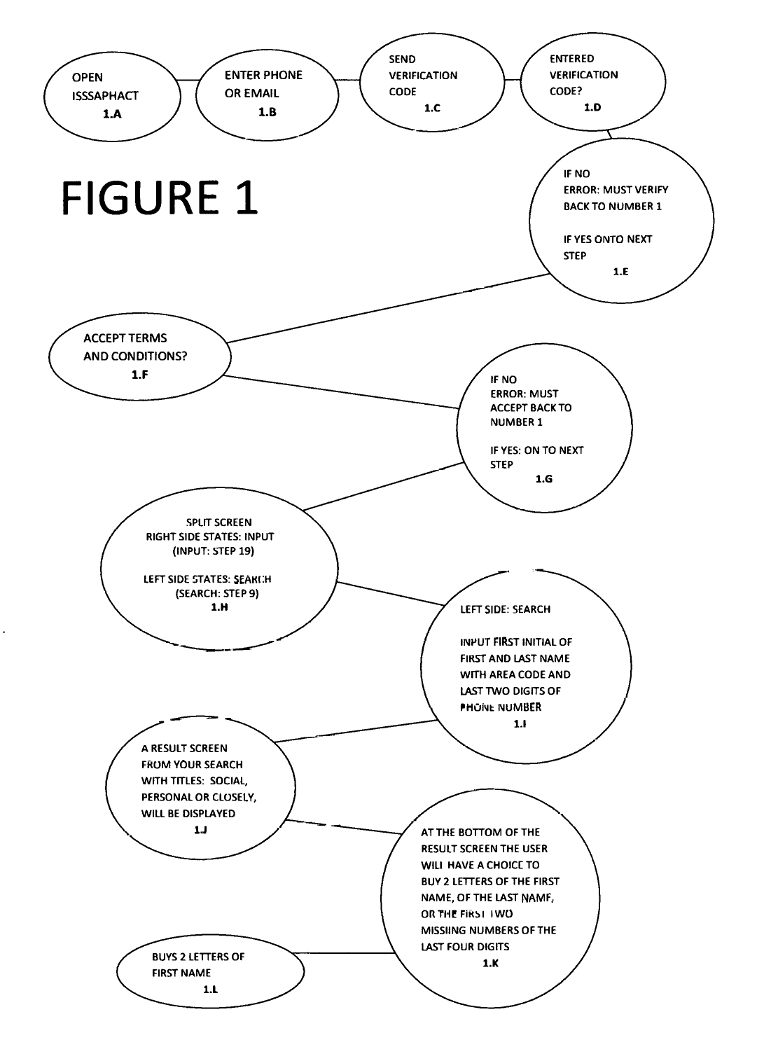

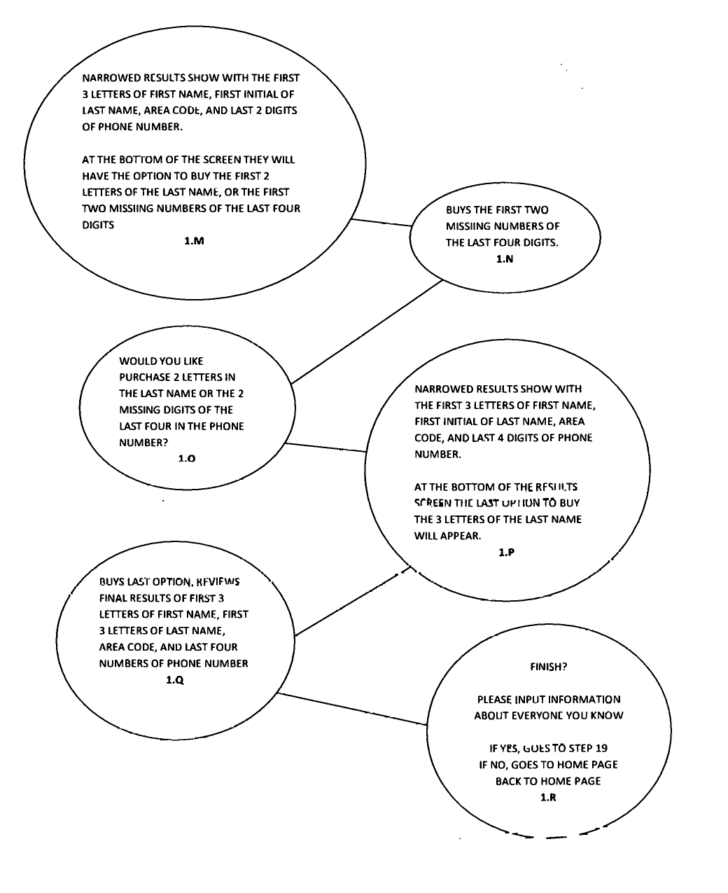

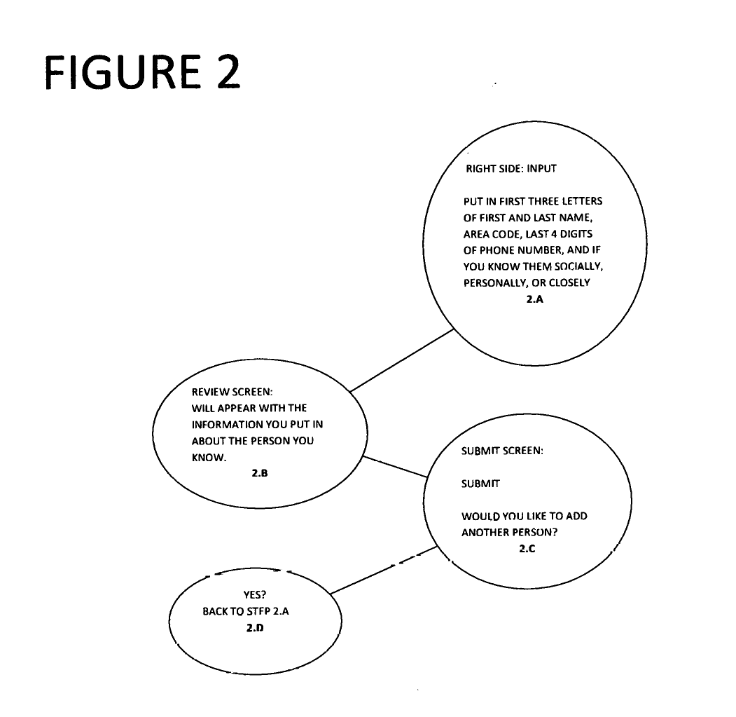

### DETAILED DESCRIPTION AND BEST MODE OF IMPLEMENTATION

The invention is made for people to find out information about other people. The application program will only provide limited information about the person being searched for. When you sign in to the application, you will have the option to input information about every person you know which will build the database. You will also have the option to obtain information about a person as well. But the catch is you will never be about to obtain all of the information about the person, the information will be limited. The only information provided will be the last two digits of the person's phone number with the area code and the first initial of the first and last name. Additional letters and numbers will be available for purchase. Once the user is satisfied with the results, they will then be able to see how many people know the person socially, personally, or closely. For example, when I sign up for ISSSAPHACT, it will ask for my phone number or email for verification and accept the terms and conditions. There will be two options, input phact or search phact. I will then push the option to search. I want to search John Johnson phone number 888-555-0000. When I push search, ISSSAPHACT will prompt a screen with: ---.---.----,.. (Please input last two digits and area code), then I input the area code with last two digits. 888.---.--00. Then another prompt, (please input first initial of first and last name.) I then put, J, J. Now I click search. All of the results of everyone with the digits I input for the phone number and those initials will pop up (database built from ISSSAPHACT/input). For example, the result is 500 people have those same initials and digits of that phone number. Now I want to narrow the results. On the results page there is an option to purchase two digits or two letters of the first or last name. To narrow down the results I choose to purchase two numbers to complete the last four digits. There will be continued options of purchase until only one digit is missing from the phone number, and also only one letter from the first and last name is missing. Finally when the results are narrowed down to the user's satisfaction, they will be able to view how many people know this person socially, personally, and closely. Example: 888.5-5.0000, Jo-n Johnson . . . Socially 230, personally 200, closely 70. . .

1. A method of utilizing a mobile device to search for limited information of a person, comprising:
(A) The input of information to obtain limited information stored and accessible by any person who downloads the application program

2. A memory for storing data for access by an application program being executed on a data processing system, comprising:
(A) A data structure stored in the memory, the data structure including information resident in a database used by the application program and including:
a) A first data object configured to create a search
b) A second data object configured to input limited information about people
c) And a third data object configured to output limited information about people to create suspense
